(19) United States
(12) Patent Application Publication
(10) Pub. No.: US 2005/0009475 A1
(43) Pub. Date: Jan. 13, 2005

(54) Transmit diversity apparatus and method in mobile communication system

(75) Inventor: In-Tae Hwang, Yongin (KR)

Correspondence Address: FLESHNER & KIM, LLP, P.O. BOX 221200, CHANTILLY, VA, 20153, US

(73) Assignee: LG Electronics Inc.

(21) Appl. No.: 10/882,264

(22) Filed: Jul. 2, 2004

(30) Foreign Application Priority Data
Jul. 11, 2003 (KR) 47322/2003

(51) Int. Cl. H04B 1/034

(52) U.S. Cl. 455/100

(57) ABSTRACT

A transmit diversity apparatus of a mobile communication system includes a receiver for BLAST-decoding receiving signals from plural reception antennas to estimate channel characteristics of forward channels of each transmission antenna. The receiver then feeds back antenna-select information for selecting a transmission antenna in a good state on the basis of the estimated forward channel characteristics. A transmitter selects transmission antennas in a good state according to the feedback antenna select information, and BLAST-codes transmission symbols for the selected transmission antennas.

### BACKGROUND OF THE INVENTION

1. Field of the Invention

The present invention relates to a transmit diversity apparatus and method in a mobile communication system.

2. Background of the Related Art

In a mobile communication system, as various multimedia services are requested, a large capacity of transmission data needs to be processed and data transfer rates need to be increased. Therefore, finding a way of increasing system capacity by using a limited radio resource is an urgent matter. In addition, a larger capacity is generally, required for a forward link than for a reverse link, so various methods for increasing the capacity of the forward link have been proposed.

One technique of increasing system capacity is to use a multiple antenna, and a BLAST (Bell Lap Layered Space-Time) technique is one way to implement the multiple antenna technique. The BLAST technique involves using plural transmission and reception antennas, where each transmission antenna simultaneously receives different data and each reception antenna detects the different data. Compared with using a single antenna, the BLAST technique can enhance transmission performance because the number of data transmitted during the same time period is increased by an amount proportional to the number of antennas used.

BLAST is classified into a D (Diagonal)-BLAST and a V (Vertical)-BLAST. Both methods covert sequentially inputted transmission data into parallel data proportional to the number of transmission antennas and both perform modulation and coding. As the transmission data is successively inputted, bit streams, (that is, a layer,) are formed equal to the number of transmission antennas. A difference between D-BLAST and V-BLAST lies in whether a transmission antenna for transmitting each layer as constructed is periodically changed.

FIG. 1 shows a schematic operation method of a related-art D-BLAST transmitter, which periodically transmits data output from a specific layer through a different transmission antenna. More specifically, data of each layer is transmitted diagonally on a spatial and temporal axis.

FIG. 2 shows a schematic operation method of a related-art V-BLAST transmitter, which transmits data of each layer through an inherent transmission antenna. More specifically, data of each layer has a vertical form on a spatial and temporal axis.

FIG. 3 is a graph showing error performance for the BLAST technique in the case where two transmission antennas are used and QPSK is used for modulation. In this graph, a receiving system adopting BLAST can detect transmission data received from each transmission antenna using zero forcing (ZF), MMSE (Minimum Mean Square Error), INV, or the like.

When the receiver compensates for influence of a channel in detecting a receiving signal, the INV method which performs only nulling and the MMSE and ZF methods which perform both nulling and canceling show different error performances depending on the number of reception antennas. That is, as the number of reception antennas increase, an SER (Symbol Error Rate) decreases. SER and the number of reception antennas are therefore inversely proportional.

FIG. 4 is a graph showing error performance according for BLAST where four transmission antennas are used and QPSK is used for modulation.

In a mobile communication system using BLAST, plural different data are transmitted and received in parallel through plural antennas in order to enhance a transfer rate. However, such a system has shortcomings. For example, even though the transfer rate is enhanced as each transmission antenna simple channel-codes the transmission data of the independent layer at the temporal and spatial region, error performance is not improved by a significant amount.

Meanwhile, in the mobile communication system for supporting a multimedia service, in order to increase the capacity of the forward link, the method of increasing the number of antennas of the mobile terminal can be used. However, in case of the mobile terminal, restrictions of power, size, weight and price make it difficult to have numerous antennas. On the other hand, the base station is not that much restricted, so that, as an alternative, the number of antennas of the base station can be increased.

Researches are attempting to devise of methods for increasing communication capacity of the forward link by increasing the complexity of the transmitter, that is, the base station, rather than by increasing the complexity of the receiver, that is, the mobile terminal. Among them is a transmit diversity technique.

The transmit diversity technique is a method where plural antennas are installed at the transmitter (base station) of the forward link to create multiple path between the transmitter (base station) and the receiver (mobile terminal), thereby obtaining a diversity gain.

The transmit diversity technique is divided into open-loop transmit diversity and closed-loop transmit diversity. The technique used depends on the existence or non-existence of feedback data. In an open loop transmit diversity method, the transmitter changes a transmission antenna at every certain time using plural transmission antennas without use of feedback data, or a simple coding technique is used. In a closed-loop transmission diversity method, the transmitter (base station) performs transmission using information on a feedback channel. In general, in case that the mobile terminal (receiver) has a low moving rate and there are many transmission antenna and reception antennas, the closed loop transmit diversity method is preferred to the open loop transmit diversity method.

One type of closed-loop transmit diversity method is known as selective transmit diversity (STD). In this method, when the receiver (mobile terminal) feeds back each state of forward channels, the transmitter (base station) selects transmission antennas in a good state, and transmits transmission data (transmission slot) through the selected transmission antennas.

For example, as shown in FIG. 5, if there are two transmission antennas, when a forward channel state indicating that the first antenna (Ant0) is in the best state is fed back, the transmitter transmits a zero-th transmission slot through the first antenna (Ant0). Meanwhile, when a forward channel state indicating that the second antenna (Ant1) is in the best state is fed back, the transmitter transmits a first transmission slot through the second antenna (Ant1). In this manner, by transmitting the transmission slot through the transmission antenna in a better state, the transmitter (base station) obtains a diversity gain.

However, in the case that the transmitter (base station) having the two transmission antennas transmits transmission data, time ‘T’ is taken for transmitting one transmission data through the best transmission antenna and time ‘2T’ is taken for transmitting two transmission data. In addition, in case of the receiver (mobile terminal) using the STD, time ‘T’ is taken for demodulating one data and time ‘2T’ is taken for demodulating two data. Therefore, though the STD technique can improve error performance by obtaining the diversity gain, it fails to improve transfer rate.

FIG. 6 is a graph showing a receiving SNT by the STD in accordance with the related art. In this graph, the receiver using the STD receives a signal from an antenna in a better state among two transmission antennas (Ant0 and Ant1), so that a receiving SNR becomes stable.

FIG. 7 is a graph showing an error performance according to the STD of the related art. In this graph, it is noted that the STD receiver has a good receiving SNR because it receives a signal transmitted through a transmission antenna in the best state among plural transmission antennas.

As mentioned above, the mobile communication system using the STD can improve error performance by obtaining the diversity gain, but in this system a considerable improvement of the transfer rate for the multimedia service is hardly expected.

### SUMMARY OF THE INVENTION

An object of the present invention is to solve one or more of the foregoing problems and to achieve at least one of the following objects and advantages of the prior art.

Another object of the present invention is to provide a transmit diversity apparatus and method in a mobile communication system which improves transfer rate and error performance in order to increase a capacity of a forward link for providing a high speed multimedia service.

Another object of the present invention is to provide a transmit diversity apparatus and method in a mobile communication system which improves transfer rate and error performance of a forward link by coupling a BLAST method and an STD method.

To achieve at least these and other objects and advantages, the present invention provides in accordance with one embodiment a transmit diversity apparatus of a mobile communication system which includes a receiver for BLAST-decoding receiving signals from plural reception antennas to estimate channel characteristics of forward channels of each transmission antenna, and feeding back antenna select information for selecting a transmission antenna in a good state on the basis of the estimated forward channel characteristics; and a transmitter for selecting transmission antennas in a good state according to the feedback antenna select information, and BLAST-coding transmission symbols for the selected transmission antennas.

In accordance with another embodiment, the present invention provides a transmit diversity method of a mobile communication system which includes BLAST-decoding receiving signals received by plural reception antennas; estimating channel characteristics of forward channels of each transmission antenna; feeding back antenna select information for selecting transmission antennas in a good state on the basis of the estimated forward channel characteristics; selecting some transmission antennas in a good state among plural transmission antennas according to the fedback antenna select information; and BLAST-coding transmission symbols for the selected transmission antennas.

### BRIEF DESCRIPTION OF THE DRAWINGS

FIG. 1 is a drawing illustrating an operation method of a D-BLAST transmitter;

FIG. 2 is a drawing illustrating an operation method of a V-BLAST transmitter;

FIG. 3 is a graph showing an error performance according to a BLAST in case that there are two transmission antennas and in case of a QPSK;

FIG. 4 is a graph showing an error performance according to a BLAST in case that there are four transmission antennas and in case of a QPSK;

FIG. 5 is a drawing illustrating a basic operation of an STD;

FIG. 6 is a graph showing a receiving SNR according to the STD;

FIG. 7 is a graph showing an error performance according to the STD;

FIG. 8 is a drawing illustrating a construction of a transmit diversity apparatus in a mobile communication system in accordance with a preferred embodiment of the present invention; and

FIG. 9 is a graph showing a BER performance according to a method coupling the STD and the BLAST in accordance with the present invention.

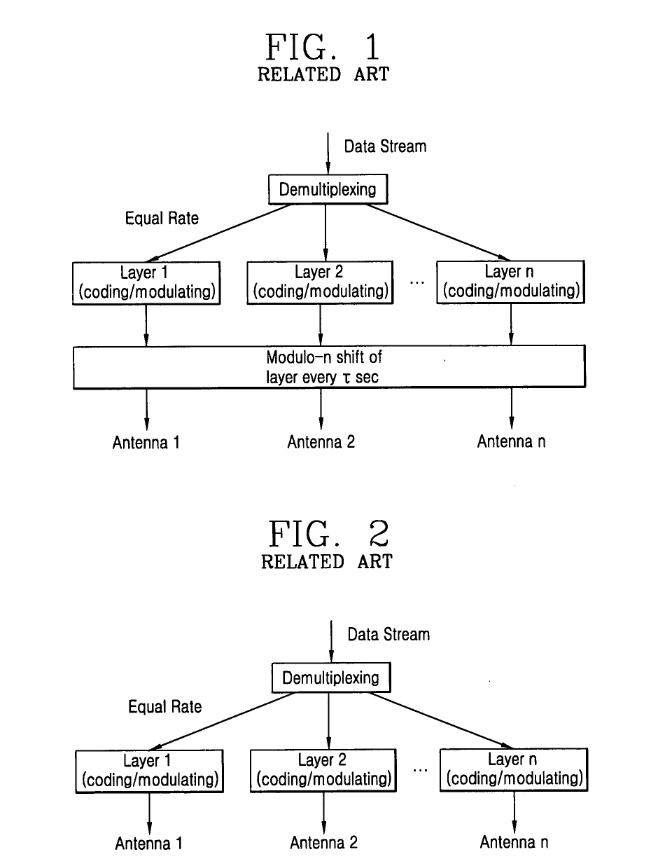

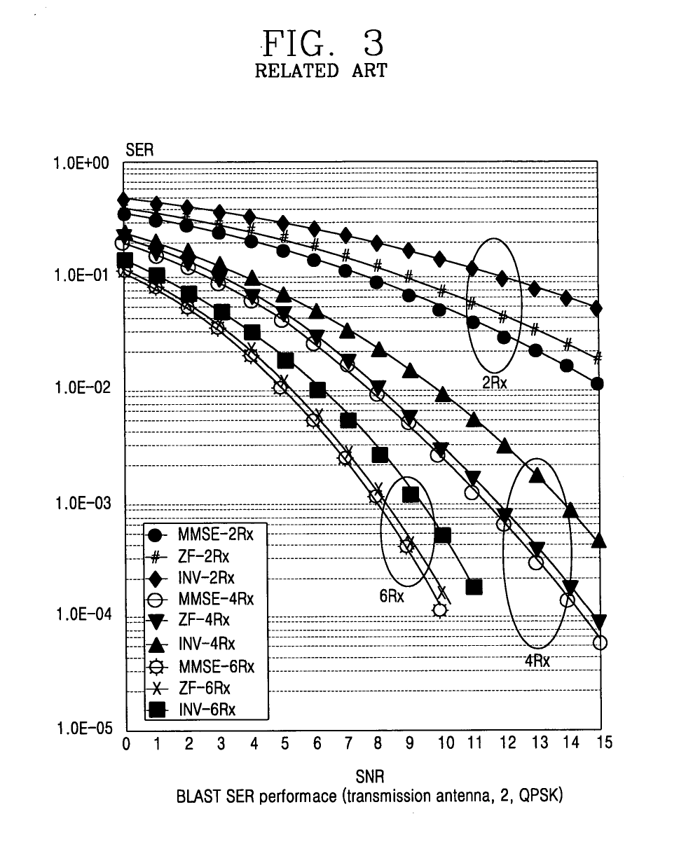

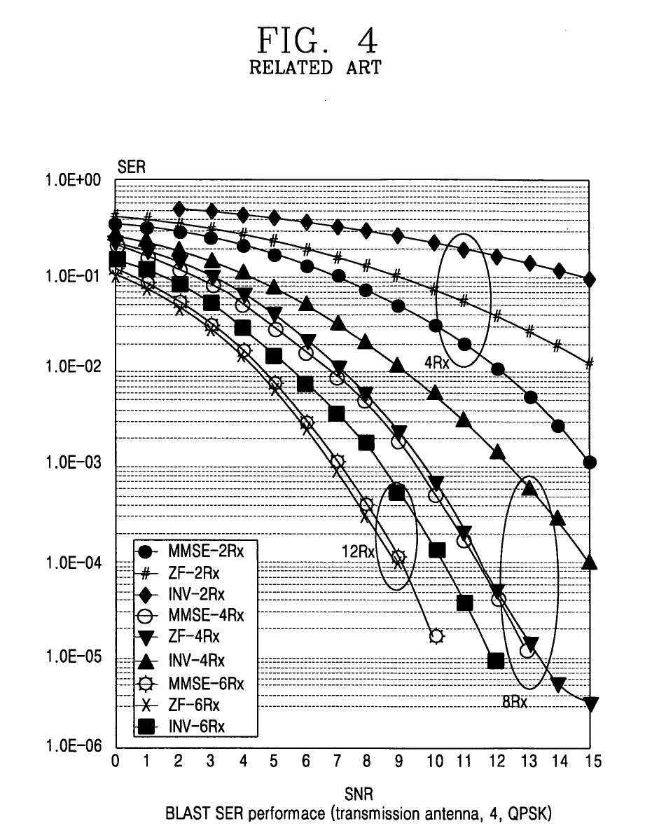

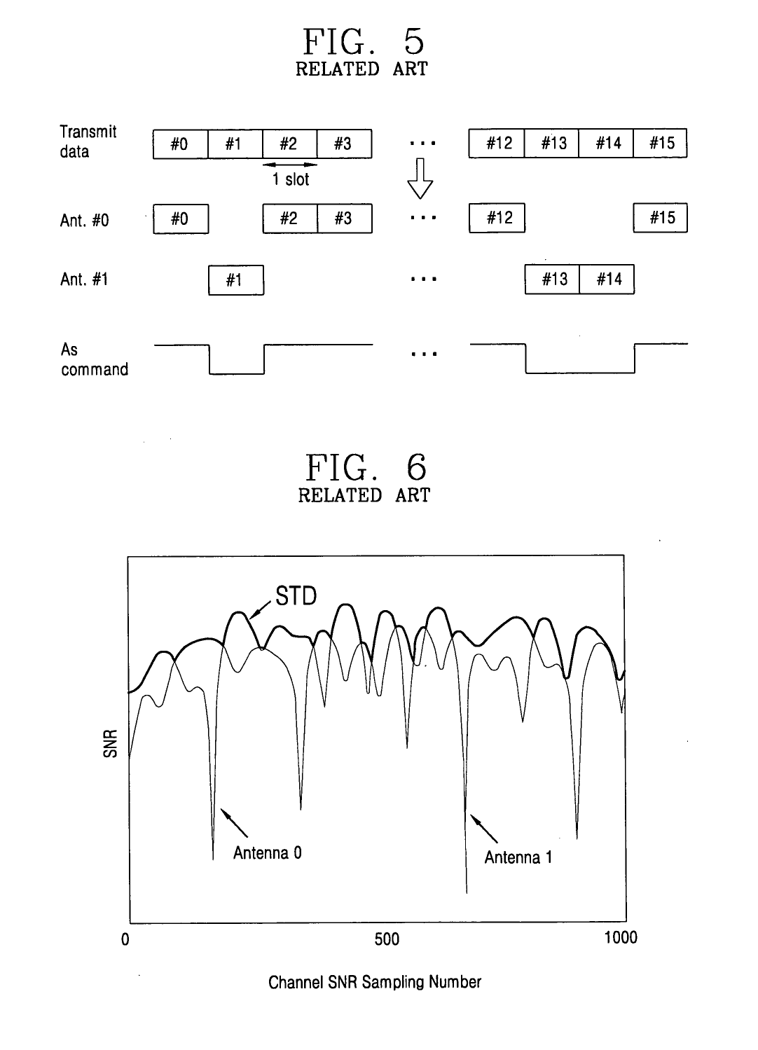

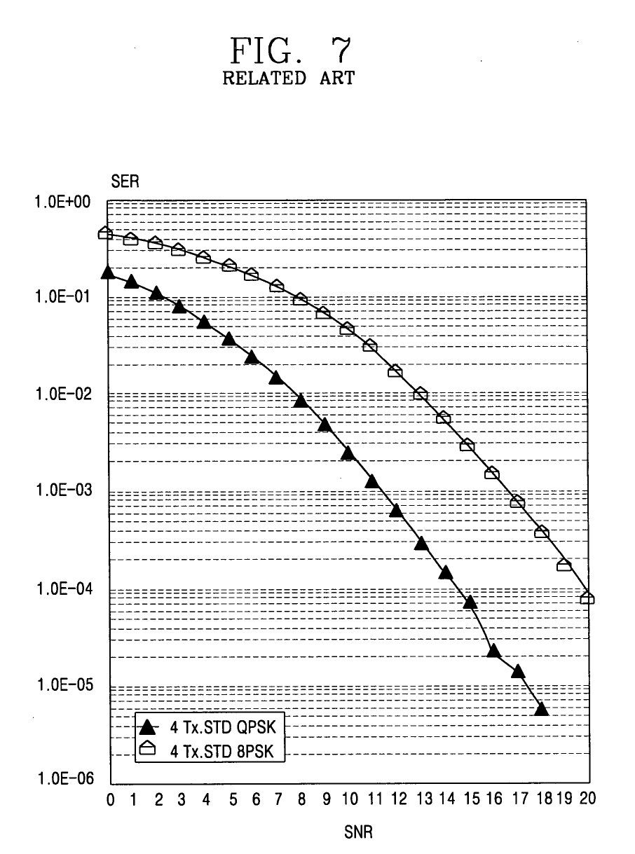

### DETAILED DESCRIPTION OF PREFERRED EMBODIMENTS

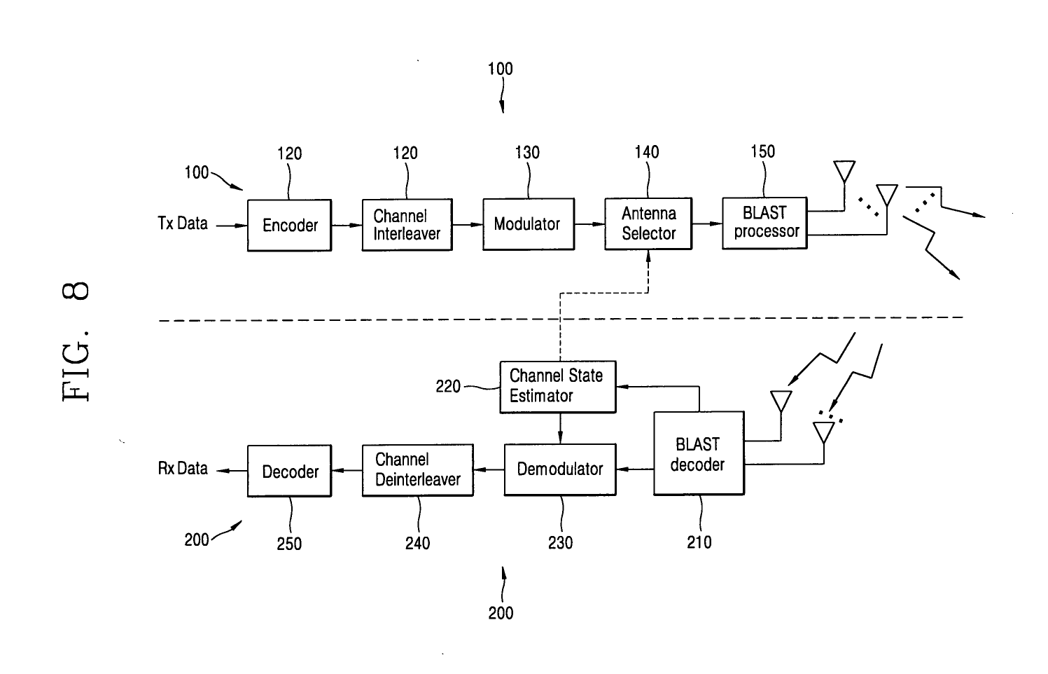

FIG. 8 is a drawing illustrating a construction of a transmit diversity apparatus in a mobile communication system in accordance with a preferred embodiment of the present invention. This apparatus includes a receiver 200 for BLAST-decoding receiving signals from a plurality of reception antennas to estimate channel characteristics of forward channels of each transmission antenna. The receiver also feeds back antenna select information for selecting a transmission antenna in a good state on the basis of the estimated forward channel characteristics. A transmitter 100 selects transmission antennas in a good state according to the feedback antenna select information and BLAST-coding transmission symbols for the selected transmission antennas.

The receiver 200 is preferably positioned in a mobile terminal, while the transmitter 100 is preferably positioned in a base station. The receiver includes a BLAST decoder 210, a channel state estimator 220, a demodulator 230, a channel deinterleaver 240, and a decoder 250. The BLAST decoder 210 BLAST-decodes receiving symbols received through plural reception antennas and detecting symbols by transmission antennas. The channel state estimator 220 estimates forward channel characteristics of each transmission antenna using the detected symbols by transmission antennas, and generates antenna select information for selecting transmission antennas in a good state among plural transmission antennas based on the estimated forward channel characteristics. The demodulator 230 demodulates symbols detected by the BLAST decoder 210 according to the estimated forward channel characteristics. The channel deinterleaver 240 channel-deinterleaves the demodulated symbols of each transmission antenna, and the decoder decodes the channel-deinterleaved data of each transmission antenna.

The transmitter 100 includes an encoder 110, channel interleaver 120, modulator 130, antenna selector 140, and BLAST processor 150. The encoder 110 encodes transmission data, the channel interleaver 120 channel-interleaves the encoded transmission data, and the modulator 130 modulates the channel-interleaved transmission data. The antenna selector 140 selects transmission antennas that are in a good state among plural transmission antennas according to antenna select information fed back from the receiver 200, and outputs the modulated transmission symbols for the selected transmission antennas. And, the BLAST-processor 150 BLAST-codes the transmission symbols so as to be transmitted in a vertical form in temporal and spatial areas through the selected transmission antennas.

Operation of the transmit diversity apparatus in a mobile communication system in accordance with the present invention will now be described. The BLAST decoder 210 of the receiver of the mobile terminal constructs receiving signals received through the plural receiving antennas as a receiving vector and regards other symbols as an interference signal, while detecting a specific symbol in order to estimate the specific symbol. Decoder 210 then subtracts a first detected signal component from the receiving vector, whereby symbols of each antenna are estimated while an influence of each symbol is minimized.

The channel state estimator 220 of the receiver estimates an SNR of the forward channel of each transmission antenna using symbols of each transmission antenna output from the BLAST decoder, and generates antenna-select information for selecting transmission antennas of forward channels that are in a good state among the estimated forward channels of each transmission antennas. The receiver then feeds back the antenna select information to the transmitter 100 of the base station.

Subsequently, the demodulator 230 of the receiver demodulates the symbols detected from the BLAST decoder according to the estimated forward channel characteristics, the channel deinterleaver channel-deinterleaves the demodulated symbols of each transmission antenna, and the decoder 250 decodes the channel-deinterleaved data of each transmission antenna.

Meanwhile, the transmitter 100 of the base station sequentially encodes, channel-interleaves and modulates the transmission data, and when the antenna select information is fed back from the receiver 200 of the mobile terminal, the antenna selector 140 of the transmitter 100 selects a transmission antenna in a good state among plural transmission antennas based on the antenna select information.

For example, if the transmitter 100 having four transmission antennas, selects two transmission antennas and applies the STD, the antenna selector 140 of the transmitter 100 selects two transmission antennas in the best state based on the antenna select information. Then, the BLAST processor 150 simultaneously transmits transmission symbols in parallel to the selected two transmission antennas through BLAST coding. At this time, the transmission symbols are demultiplexed for the two selected transmission antennas to form two transmission symbol layers, and the two transmission symbol layers are simultaneously transmitted in a vertical form in a temporal and spatial area through each selected transmission antenna.

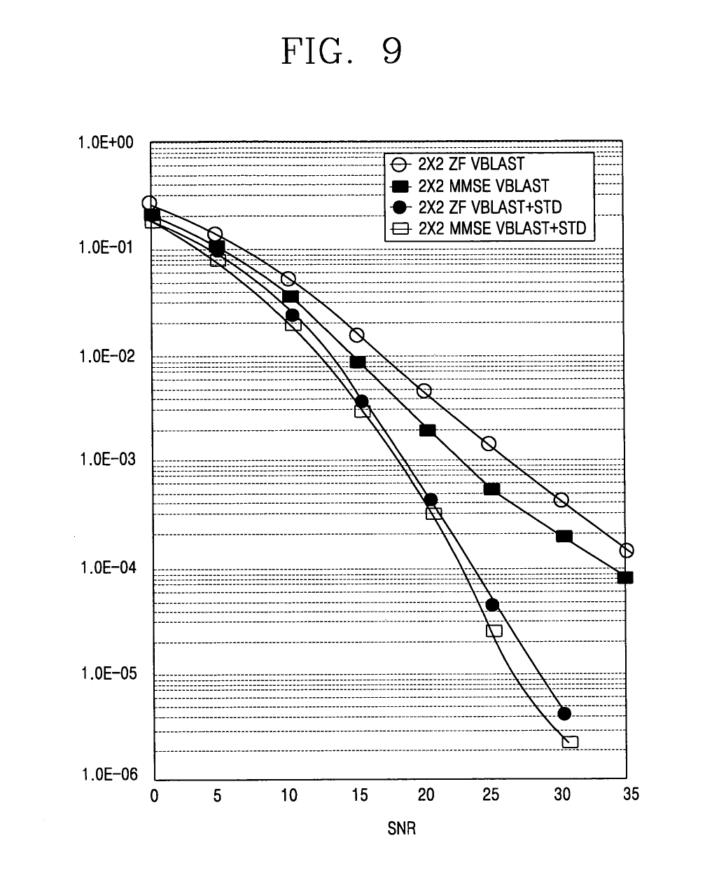

FIG. 9 is a graph showing a BER performance according to a method coupling the STD and the BLAST in accordance with the present invention.

It is noted in FIG. 9 that the transmit diversity apparatus coupling the STD which selects two from four transmission antennas and the BLAST has a better BER (Bit Error Rate) than that of the BLAST apparatus.

As so far described, the transmit diversity apparatus and method in a mobile communication system has at least the following advantages.

Because the transmission antennas in the best state are selected from plural transmission antennas using STD and the transmission symbols are simultaneously transmitted to the selected transmission antennas using the BLAST, a transfer rate and an error performance are substantially improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A transmit diversity apparatus of a mobile communication system, comprising:
a receiver which BLAST-decodes receiving signals from a plurality of reception antennas to estimate channel characteristics of forward channels of each of a plurality of transmission antennas, and which feeds back antenna select-information for selecting one or more of the transmission antennas based on the estimated forward channel characteristics; and
a transmitter which selects one or more of the transmission antennas that are in a good state according to the feedback antenna-select information, and which BLAST-codes transmission symbols for the selected transmission antennas.

2. The apparatus of claim 1, wherein the receiver is in a mobile terminal, while the transmitter is in a base station.

3. The apparatus of claim 1, wherein the receiver comprises:
a BLAST decoder which BLAST-decodes receiving symbols received through the reception antennas and detects symbols by the transmission antennas;
a channel state estimator which estimates forward channel characteristics of each transmission antenna using the detected symbols by the transmission antennas, and which generates the antenna-select information for selecting the transmission antennas in a good state among the plurality of transmission antennas based on the estimated forward channel characteristics;
a demodulator which demodulates symbols detected by the BLAST decoder according to the estimated forward channel characteristics;
a channel deinterleaver which channel-deinterleaves the demodulated symbols of each transmission antenna; and
a decoder which decodes the channel-deinterleaved data of each transmission antenna.

4. The apparatus of claim 1, wherein the transmitter comprises:
an encoder which encodes transmission data;
a channel interleaver which channel-interleaves the encoded transmission data;
a modulator which modulates the channel-interleaved transmission data;
an antenna selector which selects transmission antennas in a good state among the plurality of transmission antennas according to the antenna-select information fed back from the receiver, and which outputs the modulated transmission symbols for the selected transmission antennas; and
a BLAST-processor which BLAST-codes the transmission symbols so as to be transmitted in a vertical form in temporal and spatial areas through the selected transmission antennas.

5. A transmit diversity method of a mobile communication system, comprising:
BLAST-decoding receiving signals received by a plurality of reception antennas;
estimating channel characteristics of forward channels of each of a plurality of transmission antennas;
feeding back antenna-select information for selecting transmission antennas in a good state based on the estimated forward channel characteristics;
selecting one or more of the transmission antennas that are in a good state based on the fedback antenna select information; and
BLAST-coding transmission symbols for the selected transmission antennas.

6. The method of claim 5, wherein the BLAST-decoding step includers:
constructing the receiving signals received through the receiving antennas as a receiving vector, and while a specific symbol is being detected, other symbols are regarded as an interference signal to thereby estimate the specific symbol, and subracting a first detected signal component from the receiving vector.

7. The method of claim 5, wherein the step of BLAST-coding includes:
forming transmission symbol layers for the selected transmission antennas, and simultaneously transmitting the transmission symbol layers in a vertical form in a temporal and spatial area to the selected transmission antenna.

8. A receiver, comprising:
a decoder which BLAST-decodes a plurality of signals; and
an estimator which estimates forward-channel characteristics of a plurality of transmission antennas based on the BLAST-decoded signals.

9. The receiver of claim 8, wherein the plurality of signals are received through a respective plurality of reception antennas.

10. The receiver of claim 9, wherein the number of reception antennas equals the number of transmission antennas.

11. The receiver of claim 8, wherein the decoder BLAST-decodes symbols received through a plurality of reception antennas and detects symbols from the transmission antennas.

12. The receiver of claim 11, wherein the estimator estimates the forward-channel characteristics of each transmission antenna based on the detected symbols.

13. The receiver of claim 8, wherein the estimator generates information indicating a state of at least one of the transmission antennas based on the estimated forward-channel characteristics.

14. The receiver of claim 13, further comprising:
a feedback unit which feeds back the state information to a transmitter.

15. The receiver of claim 8, wherein the forward-channel characteristics include a signal-to-noise ratio of a forward channel associated with each of the transmission antennas.

16. The receiver of claim 15, wherein the estimator generates state information for the forward channel of each transmission antenna based on said signal-to-noise ratio.

17. The receiver of claim 16, wherein the state information designates only those transmission antennas that are in a good state as determined by corresponding signal-to-noise ratios.

18. A mobile terminal which includes the receiver of claim 8.

19. A transmitter, comprising:
a selector which selects at least one of a plurality of antennas based on state information received from a receiver; and
an encoder which BLAST-encodes signals to be transmitted through the selected antennas.

20. The transmitter of claim 19, wherein said state information indicates that forward channels associated with each of the selected antennas are in a good state.

21. The transmitter of claim 20, wherein the good state is determined based on a signal-to-noise ratio for the forward channels associated with each selected antenna.

22. A base station having the transmitter of claim 19.

23. A method for controlling transmission of data, comprising:
BLAST-decoding a plurality of signals; and
estimating forward-channel characteristics of a plurality of transmission antennas based on the BLAST-decoded signals.

24. The method of claim 23, further comprising:
receiving the plurality of signals through a respective plurality of reception antennas.

25. The method of claim 24, wherein the number of reception antennas equals the number of transmission antennas.

26. The method of claim 23, wherein the decoding step includes:
BLAST-decoding symbols received through a plurality of reception antennas; and
detecting symbols from the transmission antennas.

27. The method of claim 26, wherein the estimating step includes:
estimating the forward-channel characteristics of each transmission antenna based on the detected symbols.

28. The method of claim 23, wherein the estimating step includes:
generating information indicating a state of at l east one of the transmission antennas based on the estimated forward-channel characteristics.

29. The method of claim 28, further comprising:
feeding back the state information to a transmitter.

30. The method of claim 28, wherein the forward-channel characteristics include a signal-to-noise ratio of a forward channel associated with each of the transmission antennas.

31. The method of claim 23, wherein the forward-channel characteristics include a signal-to-noise ratio of a forward channel associated with each of the transmission antennas.

32. The method of claim 31, wherein the estimator generates state information for the forward channel of each transmission antenna based on said signal-to-noise ratio.

33. The method of claim 32, wherein the state information designates only those transmission antennas that are in a good state as determined by corresponding signal-to-noise ratios.

34. A method for controlling transmission of data, comprising:
selecting at least one of a plurality of antennas based on state information received from a receiver; and
BLAST-encoding signals to be transmitted through the selected antennas.

35. The method of claim 34, wherein said state information indicates that forward channels associated with each of the selected antennas are in a good state.

36. The method of claim 35, wherein the good state is determined based on a signal-to-noise ratio for the forward channels associated with each selected antenna.
